(19) United States
(12) Patent Application Publication
(10) Pub. No.: US 2017/0053490 A1
(43) Pub. Date: Feb. 23, 2017

(54) INTEGRATED ACCOUNTING SYSTEM FOR MULTI-PLATFORM GAMING

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/238,844

(22) Filed: Aug. 17, 2016

Related U.S. Application Data
(60) Provisional application No. 62/206,655, filed on Aug. 18, 2015.

(51) Int. Cl. G07F 17/32; G07F 17/34; A63F 13/30

(52) U.S. Cl. CPC G07F 17/3244; A63F 13/30; G07F 17/3288; G07F 17/3255; G07F 17/3246; G07F 17/3253; G07F 17/3248; G07F 17/3209; G07F 17/3293; G07F 17/329; G07F 17/34; G07F 17/3295

(57) ABSTRACT

A gaming system includes an accounting system or host which unifies and integrates funds and payment transactions relative to different gaming systems or platforms, such as land based gaming systems having associated gaming devices such as slot and video gaming machines, video lottery or server-based systems having associated terminals, and online gaming systems.

### RELATED APPLICATION DATA

This application claims priority to U.S. Provisional Application Ser. No. 62/206,655, filed Aug. 18, 2015.

### FIELD OF THE INVENTION

The present invention relates to gaming systems which are configured to present wagering games.

### BACKGROUND OF THE INVENTION

Originally casinos presented wagering games at physical tables or at individual mechanical slot machines. With the advent of modern electronic gaming machines and tables, gaming machines, tables and other gaming equipment could be linked to one another and/or with other devices. However, different systems were generally developed for different gaming related purposes. For example, a player tracking system might be developed and linked to multiple gaming machines to track player game play at the machines. A single casino might end up operating multiple, different systems relative to its gaming machines.

With the advent of online and server-based gaming, additional complexities have arisen. Online and server-based gaming systems have been developed entirely separate from a casino's gaming system which links gaming machines on the casino floor. This is problematic for casinos or other operators who are then operating entirely different systems relating to traditional casino-style gaming machines, newer server-based gaming machines, and now online gaming systems.

### SUMMARY OF THE INVENTION

Embodiments of the invention comprise a gaming system which includes an accounting system or host which unifies and integrates funds and payment transactions relative to different gaming systems or platforms, such as land based gaming systems having associated gaming devices such as slot and video gaming machines, video lottery or server-based systems having associated terminals, and online gaming systems.

Further objects, features, and advantages of the present invention over the prior art will become apparent from the detailed description of the drawings which follows, when considered with the attached figures.

### DESCRIPTION OF THE DRAWINGS

FIG. 1 schematically illustrates a system in accordance with the present invention.

FIG. 2 illustrates an embodiment of a gaming machine of the system illustrated in FIG. 1.

FIG. 3 illustrates aspects of funds accounts and exchanges of funds information in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise a method and system for integrated accounting for multi-platform gaming. In accordance with the present invention, different gaming systems and devices are linked, including, but not limited to: (1) one or more online gaming systems which are configured to present online games, such as to player computing or presentation devices; (2) one or more video lottery or server based gaming systems, such as which are configured to present games via video lottery or casino gaming terminals; and (3) one or more casino gaming systems, such as including casino management servers (“CMS”) and associated gaming devices such as video and slot machines, gaming tables and other devices. The present invention acts as a centralized monetary processing and accounting system between the various different gaming systems or platforms.

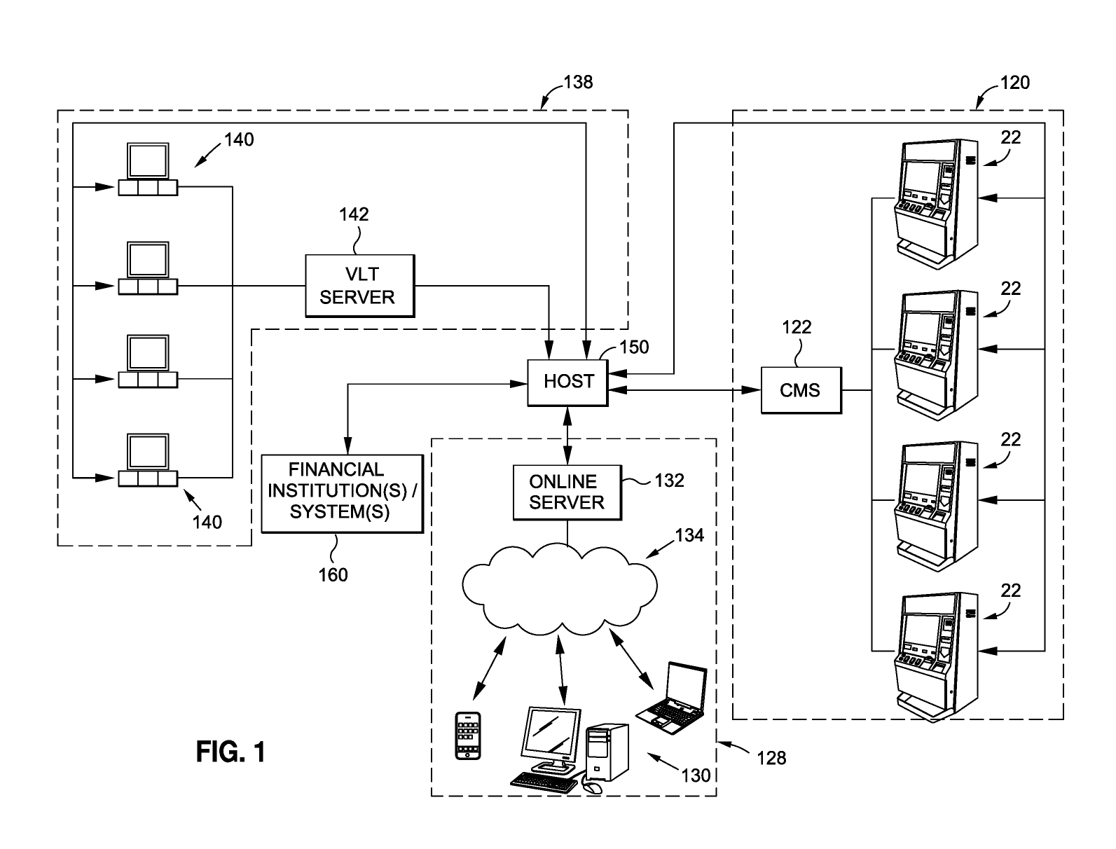

FIG. 1 schematically illustrates features of one embodiment of a gaming system 100 in accordance with the invention. The gaming system 100 may include one or more traditional casino gaming systems 120. In those gaming systems 120, one or more gaming devices may be associated with a gaming or casino management system (“CMS”). Such a system may include at least one host or casino management server 122. The casino management host 122 may comprise one or more computing devices, such as servers, which are in communication with the gaming devices.

The gaming devices may comprise gaming machines 22, mobile gaming devices such as hand-held or tablet devices, or other devices such as electronic gaming tables and the like, as are well known.

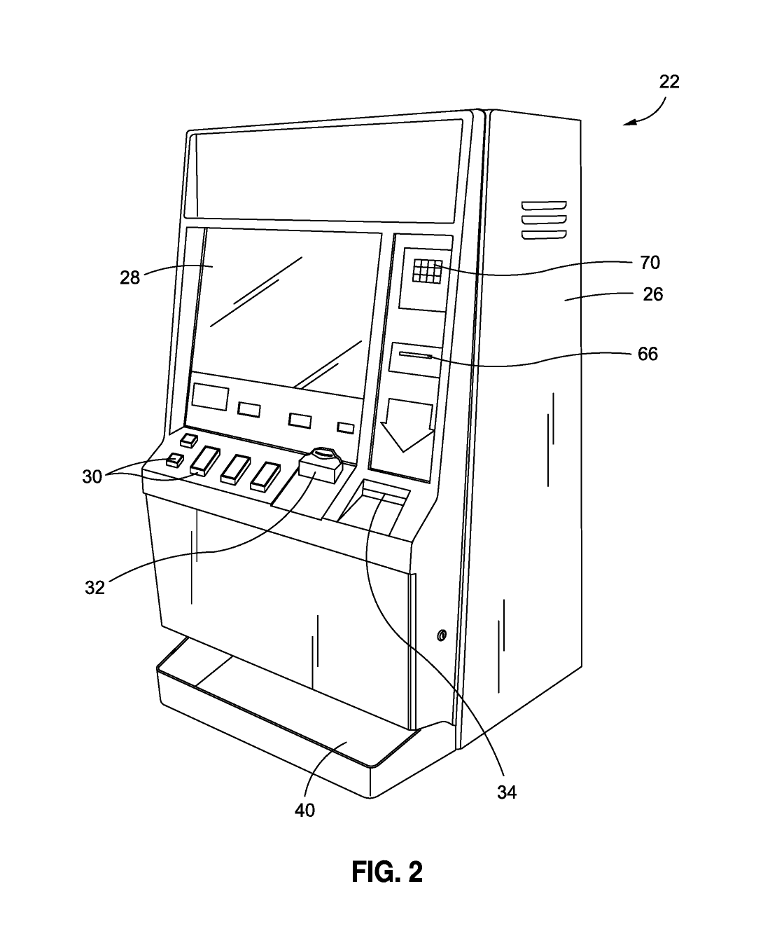

One example of a gaming machine 22 of a casino gaming system 120 is illustrated in FIG. 2. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information, such as pay table information. The gaming machine 22 may also include one or more random number generators for generating random numbers, such as for use in selecting slot symbols, cards or other game symbols or information (which depends on the game being implemented) and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. It will be appreciated that the machine readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOB s, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 2 is only exemplary of one embodiment of a gaming machine. For example, it is possible to for the gaming machine to have various other configurations, including different shapes and styles and having different components than as just described. Such gaming machines may be referred to a spinning reel or “slot” machines (such as when configured to include spinning reel type displays or to display spinning reel type video information) or video gaming machines, and may be configured to implement a variety of games now known or later developed, including, but not limited to slot games, poker games, blackjack games, lotteries, bingo games, keno games, roulette games, baccarat games and others.

The gaming system 100 might include one or more online gaming systems 128. Such systems 128 might be configured to present games via communication links or networks to one or more computing or presentation devices 130, such as a home or office computer or a player's mobile electronic device such as a PDA, phone or the like. In one embodiment, one or more games (preferably wager based games) may be presented at those devices 130 via one or more online game servers 132. For example, a player might log into a game server 132 and the controller thereof might cause game information to be delivered to the player's computing device 130 via a communication link. The communication link might comprise or include the Internet and/or other networks, such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a player's computing device. The local controller at the gaming machine or the player's computer or other electronic device may then cause game information to be displayed on one or more associated displays.

As illustrated in FIG. 1, the gaming system 100 may also include one or more video lottery or server-based gaming systems 138. Such a system 138 might include one or more video lottery terminals (“VLTs”) 140 or similar devices, such as server-based casino gaming terminals.

These video lottery or server-based casino terminals 140 may be display devices or computing devices which are configured to present one or more games, such as wagering games including video lottery games, or to display the outcomes of such games.

The terminals 140 may be associated with one or more servers 142, such as video lottery or casino game servers. The servers 142 may be connected to the terminals 140 and be configured to enable or track the presentation of video lottery games at the terminals 140.

In accordance with the invention, monetary or monetary value transactions such as wagers, payments, fund deposits and winnings relative to each of the individual gaming systems or platforms can be centrally integrated or managed. This permits, for example, a player to place wagers from a single balance of funds upon games played on any of the platforms, to have winnings from any of those systems or platforms to be credited back to the same balance of funds, to use funds from one system for use in another system, etc.

In one embodiment, the gaming system 100 thus includes a money management or central accounting system. Such a system may include one or more accounting servers or hosts 150. The money management system may also include other devices such as ticket-dispensing kiosks, ticket-cashing kiosks, cash-dispensing kiosks (such as from a credit card or debit card), ATMs, and/or other devices.

Aspects of the accounting host 150 may be implemented as hardware and/or software. For example, the accounting host 150 may comprise a computing device which is configured to execute computer software in the form of computer readable code executed by a processor thereof, or bytecode class files executable within a Java™ runtime environment running on such a computer, or bytecodes running on a processor (or devices enabled to process bytecodes) existing in a distributed environment (e.g., one or more processors on a network).

Such a computer or computing device may include a video memory (not shown), a main memory (not shown) and a mass storage (not shown), all coupled to system bus (not shown) along with user inputs devices such as a keyboard and/or mouse (not shown), and one or more processors. The mass storage may include both fixed and removable media, such as magnetic, optical or magnetic optical storage systems or any other available mass storage technology. The system bus may contain, for example, thirty-two address lines for addressing video memory or main memory. The system bus also includes, for example, a 64-bit data bus for transferring data between and among the components, such as processor, main memory, video memory and mass storage. Alternatively, multiplex data/address lines may be used instead of separate data and address lines.

The computing device may also include a communication interface coupled to the system bus. Communication interface provides a two-way data communication with external systems and devices.

Application code or “software” which is executed by the computing device may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves. The computer systems described above are for purposes of example only. An embodiment of the invention may be implemented in any type of computer system or programming or processing environment.

In accordance with the present invention, the accounting host 150 is configured to centralize or integrate the monetary transactions occurring with or relative to the different gaming systems or platforms. As such, the accounting host 150 is configured to communicate or interface with each of those systems or platforms. The various systems and devices may be configured to communicate with one another in various fashions. For example, each device may include one or more communication ports or interfaces. The devices may be linked by various communication links. These links may be wired or wireless, including local area networks (“LANs”), wide area networks (“WANs”), public or provide networks such as the Internet and the like. The devices may also be configured to communicate by various methods or protocols. For example, the devices might be configured to communicate using one or more standard communication protocols, such as the known System to System (“S2S”), Game to System (“G2S”) or Slot Accounting System (“SAS”) communication protocols. The devices might also be configured to implement or communicate via one or more application program interfaces (“APIs”). The devices could also communicate by one or more other protocols, such as TCP/IP.

In this manner, the accounting host 150 may receive information regarding financial transactions occurring at or relative to each of the gaming systems or platforms (including the servers and gaming devices thereof) and to transmit financial information to each of those gaming systems or platforms.

In addition, in one embodiment, the accounting host 150 may communicate with one or more external devices or systems. For example, as illustrated in FIG. 1, the accounting host 150 may communicate with one or more financial systems or financial institutions 160. As one example, the accounting host 150 may communicate with a bank which manages one or more bank accounts of a player.

In one embodiment of the invention, the accounting host 150 manages one or more player financial or wagering accounts 170, which accounts may be referred to herein as “central” funds or wagering accounts. Each central wagering account 170 may comprise an electronic wallet or other type of account and may be used by a player to place wagers relative to games presented via the different gaming systems or platforms and to receive winnings or payments from those different gaming systems or platforms.

A player may have one central wagering account or more than one wagering account. Preferably, identification or access information is associated with each central wagering account. This information may be used by a player or the system to identify a particular account relative to a player's activity. The identification information might comprise, for example, a player card, RFID tag or other media which bears or has identifying information associated therewith, or identification information (such as a code, account number or the like) which the player can input to the system 100.

A player must provide funds in order to make wagers. The player might associate funds with their central wagering account 170, such as by requesting a fund transaction with one or more designated external bank accounts (checking or savings account, as one example) or other financial accounts. Such transactions are well known. A player might also deposit funds with a casino (either in cash/coins or electronically) and have the casino or other entity associate those funds with the player's central wagering account 170. A player might also provide the funds to a gaming device (such as in the form of currency, bank card or the like). Those funds might be transferred to the player's central wagering account 170 immediately or they might be credited to the gaming device (such as in the form of one or more credits) and then be transferred to the player's central wagering account at a later time (such as after the player has completed game play at the gaming device, wherein any remaining funds balance at that gaming device is then transferred to the player's central wagering account). A player may also transfer funds from one of their central wagering accounts to another of their central wagering accounts, receive funds from a different player's central wagering account (upon initiation or approval of the other player) or transfer funds to another player's central wagering account(s).

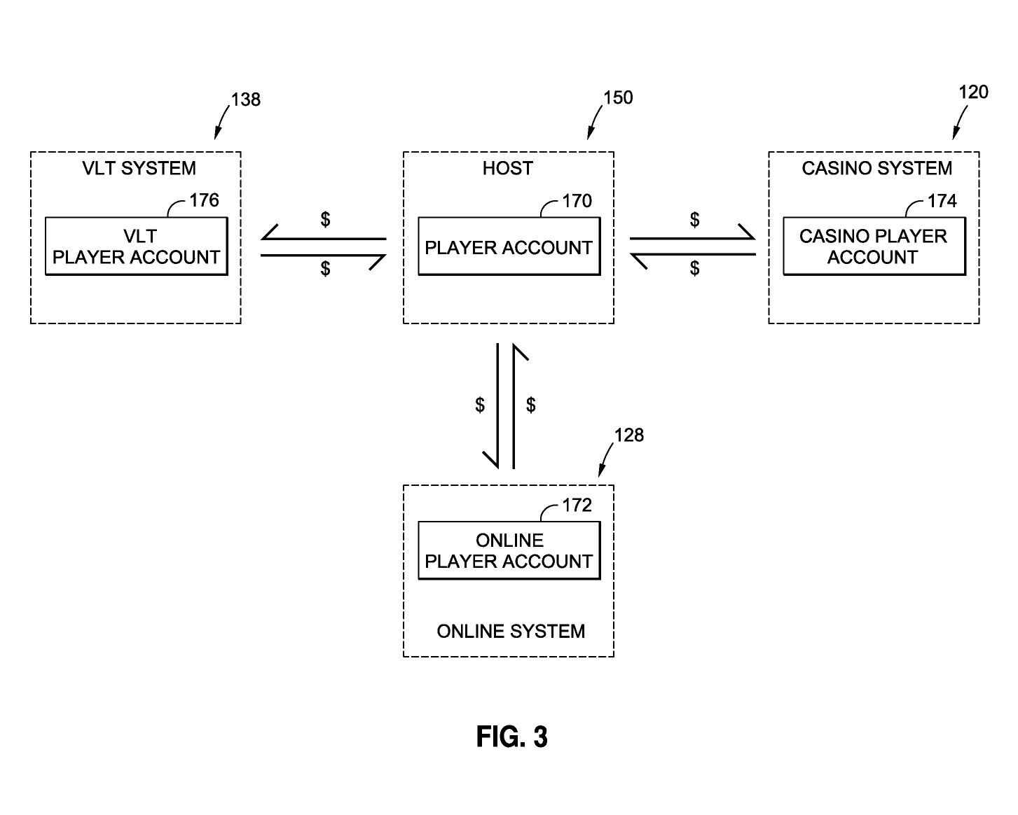

In accordance with the invention and as illustrated in FIG. 3, a player may use or wager funds in their central wagering account 170 to fund wagers or game play via any of the different gaming systems or platforms. In addition, winnings from those different systems or platforms may be credited back centrally to the player's central wagering account(s).

As one example, a player may provide $1000.00 in currency to a casino. The casino may credit this $1000.00 to the player's central wagering account 170. The player might go to one of the gaming machines 22 associated with the casino's gaming system 120 and place a $100 wager on a video poker game (the player may use their identification information to access their wagering account at the gaming machine). This wager would be reported from the casino gaming system 120 back to the accounting host 150, thus reducing the funds balance in the player's central wagering account to $900. The player might win $500 on that wager. This winning would be reported back to the accounting host 150, thus increasing the player's funds balance to $1400.

The player might then leave the casino and go home. The player might desire to play one or more wagering games via the online gaming system 128, such as via a home computer 130. In that instance, the player may again provide information to access their central wagering account. When the player places a wager, the online game server 132 may communicate the wager to the accounting host 150 so as to deduct the amount of the wager. In the event the player is awarded winnings, the winning amounts may be transmitted from the online game server 132 to the accounting host 150 in order to credit the player's central wagering account 170.

Of course, the player's central wagering account might be used for other purposes. For example, a player might use funds in their account to pay for other goods or services (a hotel room associated with the casino, a restaurant bill, show tickets, etc.).

In one embodiment, the accounting host 150 may also interface with other player accounts. For example, a player might have an online player account 172, a casino player account 174 and/or a VLT/server-based game account 176. Each of these accounts may be associated with their respective systems or platforms, such as managed by the online server 132, the casino management system 122 or the VLT server 142, or accounting servers or hosts of those particular systems.

In accordance with the invention, a player may move funds between those individual accounts via the accounting host 150 or move funds from any of those accounts to the player's central wagering account 170 or from the player's central wagering account 170 to any of those other accounts, via the accounting host 150.

For example, a player might have an online player account 172 which is associated with the online gaming system 128. The player might have $2500.00 in that account. If the player is at a gaming machine 22 in the casino, the player might move $1000.00 from their online player account 172 to their central wagering account 170. In such a situation, a request may be transmitted from the accounting host 150 to the online server 132 or an accounting host of the online gaming system 128 to cause $1000.00 to be deducted from that account and transferred to the player's central wagering account 150. In an alternate embodiment, the player could simply request that wagers placed at the gaming machine 22 be deducted from the player's online player account 172. Assuming the player places a $10 wager at the gaming machine 22, that wager is transmitted from the casino gaming system 120 to the accounting host 150 and from the accounting host 150 to the online gaming system 128 which reduces the player's funds balance in that account by $5 (and transfers the funds to the accounting host 150 for reconciliation with the wager at the casino gaming system 120).

In another embodiment of the invention, it is possible for the player to not have a central wagering account 170. Instead, the accounting host 150 may simply facilitate transactions between or with the different player accounts, such as the player's online account 172, casino account 174 and VLT account 176. For example, a player might, as indicated above, use funds from one account for wagering in another environment, as facilitated by the accounting host 150.

It will be appreciated that the gaming system 100 may include additional elements other than those which are illustrated in FIG. 1 or may be otherwise configured differently (such as including only an online gaming system 128 and a casino gaming system 120). For example, the gaming system 100 might include one or more jackpot systems (not shown) which are configured to present or enabled one or more jackpots. Such jackpots may be of any variety, such as based upon particular game events or outcomes or “mystery” jackpots, as are well known. The jackpots may be fixed or progressive value. The jackpot system may comprise or be enabled by one or more jackpot controllers.

The gaming system 100 may also include one or more remote game systems or servers (not shown). Such game servers may be configured to generate or provide games or game content.

Of course, the gaming system 100 might include other systems or devices other than those just described.

The method and system of the invention has numerous advantages and features. For example, the invention permits the unification of land-based casino gaming systems and associated gaming machines, VLT or server-based systems and terminals, and online gaming systems.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming system comprising:
at least two different gaming platforms comprising at least two of:
a casino gaming system comprising at least one casino management server linked to a plurality of gaming machines configured to present wagering games;
an online gaming system comprising at least one online game server configured to present games to one or more wagering games to one or more remote presentation devices via one or more communication links; and
a video lottery or server-based gaming system comprising at least one game server configured to present wagering games via one or more game terminals; and
at least one accounting host in communication with said at least two different gaming platforms, said at least one accounting host configured to exchange funds transaction information with both of said two different gaming platforms.
